(19) United States
(12) Patent Application Publication
(10) Pub. No.: US 2025/0376805 A1
(43) Pub. Date: Dec. 11, 2025

(54) HIGH-TEMPERATURE COVER

(71) Applicant: MID-MOUNTAIN MATERIALS, INC., Seattle, WA (US)

(72) Inventors: John R. Knapp, Seattle, WA (US); Marie Christine Gallanar, Issaquah, WA (US)

(73) Assignee: MID-MOUNTAIN MATERIALS, INC., Seattle, WA (US)

(21) Appl. No.: 19/234,510

(22) Filed: Jun. 11, 2025

Related U.S. Application Data
(60) Provisional application No. 63/658,767, filed on Jun. 11, 2024.

(51) Int. Cl. D06N 3/18; A47J 37/07; D04H 1/4382; D04H 1/492; D06N 3/00; D06N 3/12

(52) U.S. Cl. CPC D06N 3/186; A47J 37/0786; D04H 1/43838; D04H 1/492; D06N 3/0011; D06N 3/128; D06N 2209/067; D06N 2209/142; D06N 2209/1678; D10B 2503/00

(57) ABSTRACT

A protective covering for an outdoor cooking appliance, the protective covering including a temperature-resistant material including a fabric layer, a resin topcoat, and a resin bottom coat; a plurality of panels formed from the temperature-resistant material, the plurality of panels being coupled at a plurality of seams to define a shell shape; and a first detachable closure defined along a portion of a first seam of the plurality of seams.

### CROSS-REFERENCE TO RELATED APPLICATION

This application claims the benefit of U.S. Patent Application No. 63/658,767, filed Jun. 11, 2024, expressly incorporated herein by reference in its entirety.

### BACKGROUND

Food is cooked using a source of heat typically introduced within an appliance. For outdoor cooking, typical appliances include a BBQ grill, a smoker, or a firepit and/or portable campfire. While outdoor cooking provides numerous advantages over cooking inside in a kitchen, weather and other environmental conditions can cause damage to an appliance left outdoors for an extended period of time. To overcome this challenge, these cooking appliances and others are often covered after cooling down to protect the apparatus from rain, wind, sun, pollen, and other sources of potential damage. These cooking appliance covers thus serve to protect the apparatus from weathering, corrosion, and degradation.

Currently, covers for outdoor cooking appliances are typically produced from vinyl coated polyester and nylon base fabrics, or from uncoated fabrics of polyester or nylon. These fabrics and coatings are flexible and relatively low cost, but such materials are neither temperature resistant, nor ultraviolet light (UV)-resistant.

This limitation of the materials used in a cover for an outdoor cooking appliance can create a number of challenges to users of outdoor cooking appliances. For instance, because traditional covers are not temperature resistant, the outdoor cooking appliance must be given adequate time to cool down to ambient temperatures before covering the outdoor cooking appliance. If the source of heat is not allowed to cool adequately, severe consequences may follow, such as the cover melting or sticking to the hot surface of the outdoor cooking appliance, the cover shrinking in part on contact with the outdoor cooking appliance, or even the cover catching on fire. These challenges can create a substantial risk of irreversible damage to the outdoor cooking appliance, to nearby permanent structures such as a house or building, and even to users and other people in proximity to the outdoor cooking appliance.

Another problem with current covers for outdoor cooking appliance is the difficulty in removing and installing the cover over the outdoor cooking appliance. Traditional covers have a form-fitting design to conform tightly to the shape of the outdoor cooking appliance. Form-fitting is an important feature of a covering for an outdoor cooking appliance to avoid having the cover removed during inclement weather conditions, such as a windstorm, which would result in exposing the outdoor cooking appliance to the inclement weather. However, this traditional design may be difficult to install and requires extensive effort by a user to position and adjust the cover. Moreover, extended UV exposure may result in shrinking of the materials used in traditional covers, exacerbating this problem.

In another instance, polyester and nylon fabrics are not UV-resistant and thus can undergo photo degradation when exposed to sunlight for an extended period of time. Coatings on the covers—such as vinyl, polyvinyl chloride (PVC), or acrylic coatings—may mitigate this problem, but such coatings are similarly susceptible to UV damage over time, which can result in a cover surface susceptible to cracking and flaking due to UV degradation. Beyond being aesthetically undesirable, such UV damage can eventually produce holes, tears, and other structural defects in the cover, thus limiting the covers ability to protect the outdoor cooking appliance. This degradation can also lead to other reductions of physical strength and tear resistant properties, which can further lessen the efficiency and aesthetic appeal of the cover.

As a result of the above limitations, the average life expectancy of a coated or uncoated polyester or nylon fabric cover is 2-5 years. This can be highly variable based on a number of factors such as geographic region, climatological conditions, daily UV light exposure, and the like. Moreover, to prevent heat damage and the instant destruction of the cover, the user may forgo covering the outdoor cooking appliance while it cools down and may subsequently forget to re-cover the outdoor cooking appliance once it has cooled down. This can result in damage to the outdoor cooking appliance that can be even more expensive.

While there have been some efforts to overcome this problem, current solutions are typically produced from high-temperature silicone-coated fiberglass fabrics. While this can avoid the damage caused by heat or UV damage, these silicone-coated fiberglass fabrics tend to be thick, heavy, and unwieldy, such that it is difficult to remove the cover from the heat source and re-cover the units with these covers. This makes it more likely a user will forgo covering the appliance to avoid the hassle, or worse, that a user may injure themselves on a hot outdoor cooking appliance as they struggle to fit the cover over the outdoor cooking appliance. Moreover, the materials for these products attract dirt and ashes which can stick to the material, rendering them difficult to clean.

Accordingly, there is a need for improved protective covers that are UV resistant, heat resistant, and intuitive and easy to install/remove. The present disclosure addresses these and other long-felt and unmet needs in the art.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, a protective covering includes: a temperature-resistant material including a fabric layer, a resin topcoat coating a first side of the fabric layer, and a resin bottom coat coating a second side of the fabric layer; a plurality of panels formed from the temperature-resistant material, the plurality of panels being coupled at a plurality of seams to define a shell shape; and a first detachable closure defined along a portion of a first seam of the plurality of seams.

In some embodiments, the temperature-resistant material has a thickness of between about 0.30 mm and about 6.0 mm. In some embodiments, the temperature-resistant material comprises short fibers selected from chopped fibers, staple fibers, or a combination thereof. In some embodiments, the temperature-resistant material comprises a non-woven fabric, a woven fabric, or a combination thereof. In some embodiments, the short fibers are waterjet entangled without the use of additional binders. In some embodiments, the short fibers have an average filament diameter of between about 4 μm and about 600 μm.

In some embodiments, the fabric layer is selected from the group consisting of NOMEX®, fiberglass, E-Glass, KEVLAR®, Basalt, S-Glass, fiberglass, Ceramic Fibers, high silica, polybenzimidazole (PBI), polyphenylene benzobisoxazole (PBO), Silica/Alumina blends, Quartz, leached silica, Alumina-Silica, specialty ceramic fibers, carbon fibers, carbon polyacrylonitrile (PAN) based fibers, polyacrylonitrile pre-oxidized fibers, and combinations thereof.

In some embodiments, the resin comprises NOMEX®, KEVLAR®, or combinations thereof.

In some embodiments, the resin is a low surface energy resin. In some embodiments, the resin is UV-resistant. In some embodiments, the resin is configured to provide a waterproof coating.

In some embodiments, the resin is selected from the group consisting of silicone, silane, siloxane, RTV, PTFE, PTF, polyvinylidene fluoride, FEP, FKM, polyurethane, and combinations thereof. In some embodiments, the resin comprises silicone.

In some embodiments, the topcoat is configured to provide a waterproof coating. In some embodiments, the bottom coat is configured to provide thermal resistance.

In some embodiments, the temperature-resistant material is resistant to a temperature of about 500° F. to about 2000° F.

In some embodiments, the first detachable closure comprises a first magnet and a second magnet in a paired configuration.

In some embodiments, the first magnet and the second magnet each have a shape, wherein the shape is a disc, a rod, a strip, a square, a rectangle, a triangle, and combinations thereof. In some embodiments, the first magnet and the second magnet are each embedded in the temperature-resistant material. In some embodiments, the two or more magnets are coupled to the temperature-resistant material by insertion into pockets, sewing into panels, by adhesive formulations, or a combination thereof.

In some embodiments, the first detachable closure is formed from a portion of a first panel of the plurality of panels and from a portion of a second panel of the plurality of panels.

In some embodiments, the portion of the first panel is configured to at least partially overlap the portion of the second panel.

In some embodiments, a second detachable closure defined along a portion of a second seam of the plurality of seams. In some embodiments, the second detachable closure is formed from a portion of the second panel of the plurality of panels and from a portion of a third panel of the plurality of panels. In some embodiments, the portion of the second panel is configured to at least partially overlap the portion of the third panel.

In some embodiments, the second detachable closure is formed from a portion of a third panel of the plurality of panels and from a portion of a fourth panel of the plurality of panels. In some embodiments, the portion of the third panel is configured to at least partially overlap the portion of the fourth panel.

In some embodiments, while the protective covering is configured to cover a cooking appliance during operation, thereby insulating the cooking appliance and providing consistent temperature-control for a food product being cooked therein.

In some embodiments, the cooking appliance is a barbeque grill, a smoker, a firepit, or a portable campfire.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an outdoor cooking appliance in accordance with an embodiment of the present disclosure;

FIG. 2A illustrates a protective covering for an outdoor cooking appliance configured to cover the outdoor cooking appliance of FIG. 1, where the protective covering is in an open configuration, in accordance with an embodiment of the present disclosure;

FIG. 2B illustrates the protective covering for an outdoor cooking appliance of FIG. 2A configured to cover the outdoor cooking appliance of FIG. 1, where the protective covering is in a closed configuration, in accordance with an embodiment of the present disclosure;

FIG. 3A illustrates a front view of a protective covering for an outdoor cooking appliance in accordance with an embodiment of the present disclosure;

FIG. 3B illustrates an isometric view of the protective covering of FIG. 3A, in accordance with an embodiment of the present disclosure;

FIG. 4A illustrates a front view of a protective covering for an outdoor cooking appliance in accordance with an embodiment of the present disclosure;

FIG. 4B illustrates an isometric view of the protective covering of FIG. 4A, in accordance with an embodiment of the present disclosure;

FIG. 5A illustrates a detachable closure for the protective covering of FIG. 2A, in accordance with an embodiment of the present disclosure;

FIG. 5B illustrates a detachable closure for a protective covering of FIG. 2A, in accordance with an embodiment of the present disclosure;

FIG. 6A illustrates a portion of the protective covering of FIG. 2A, in accordance with an embodiment of the present disclosure;

FIG. 6B illustrates a portion of the protective covering of FIG. 2A, in accordance with an embodiment of the present disclosure; and

FIG. 7 illustrates an order of the layering of materials in the protective covering of FIG. 2A, in accordance with an embodiment of the present disclosure.

### DETAILED DESCRIPTION

The current invention relates, generally, to protective coverings constructed from a temperature-resistant material and with an automatic closure design, and more precisely, to protective coverings for an outdoor cooking appliance. Accordingly, while the protective coverings of the present disclosure may be used as a covering for any object in any context, such as motor-operated vehicles or other machinery which can become hot during operation, in the interest of clarity, the protective covering will be described in the context of a protective covering for an outdoor cooking appliance.

The protective coverings described in the present disclosure include a temperature-resistant material, a plurality of panels formed from the temperature-resistant material and coupled at a plurality of seams to define a shell shape, and a first detachable closure defined along a portion of a first seam of the plurality of seams. The first detachable closure thus advantageously allows a user to install the protective coverings described in the present disclosure quickly and without a struggle to align the protective covering with an outdoor cooking appliance. In this manner, in some embodiments, the detachable closures are configured to self-install, with gravity pulling portions of the detachable closure into position, and where the detachable closures are configured to self-seal once in proximity in any of the manners described below.

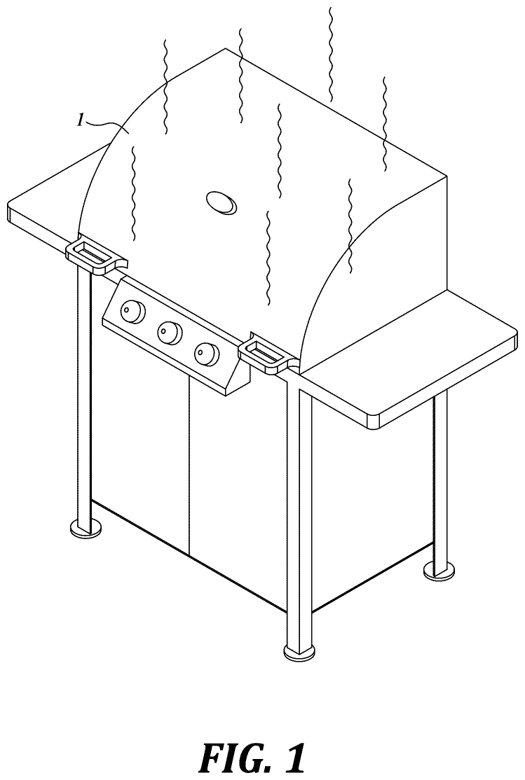

FIG. 1 provides an example of an outdoor cooking appliance 1 in the form of a BBQ grill. In that regard, the outdoor cooking appliance 1 may be covered by any of the protective coverings discussed herein.

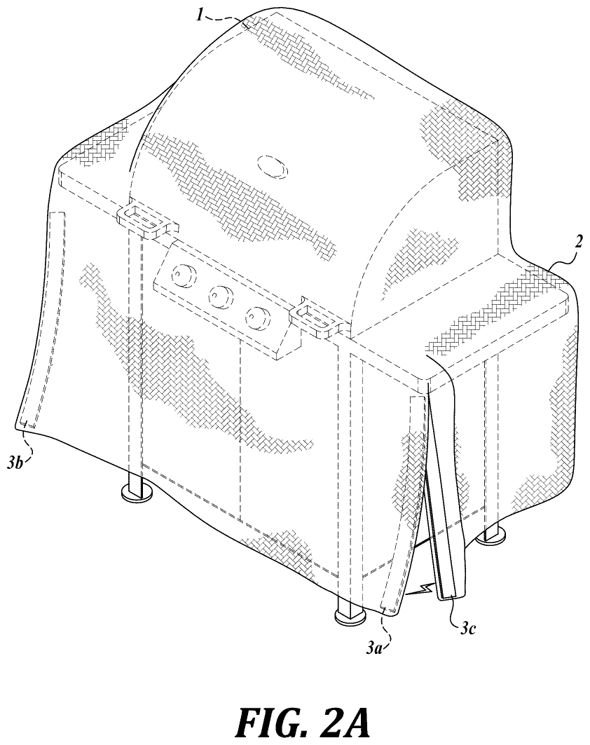

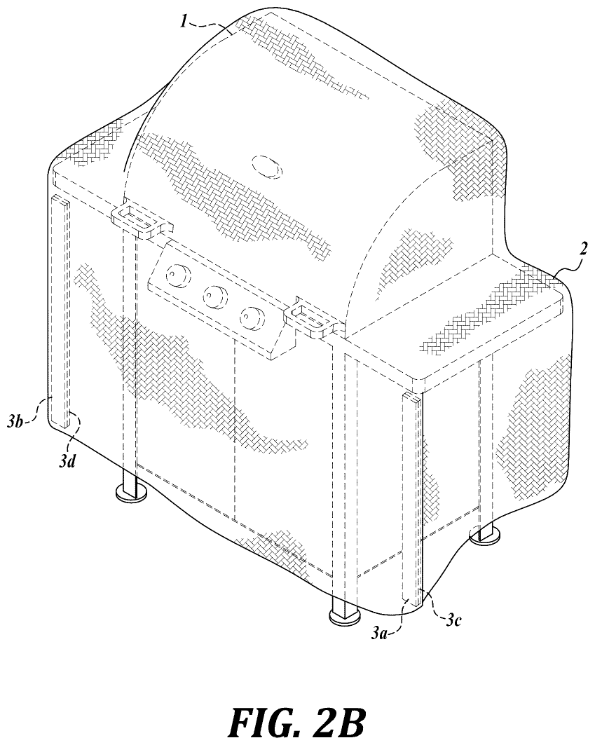

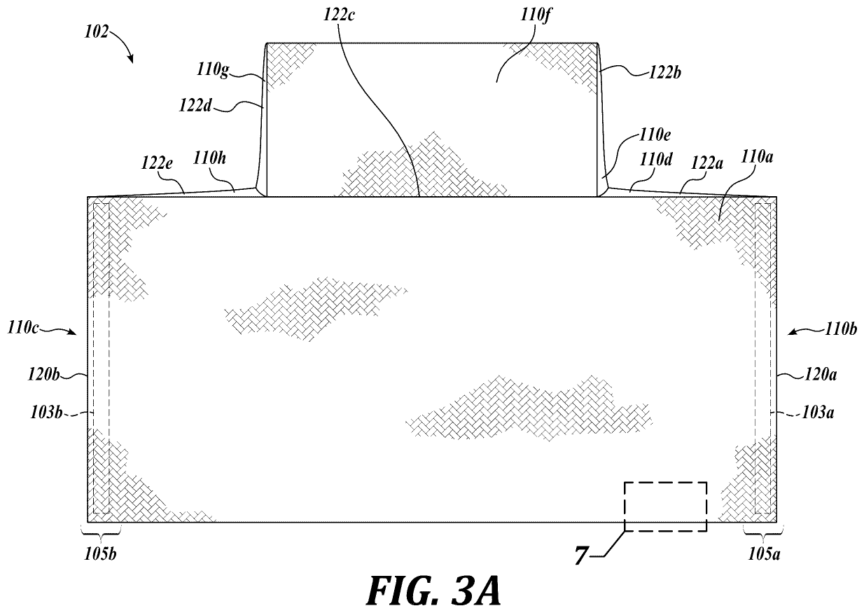

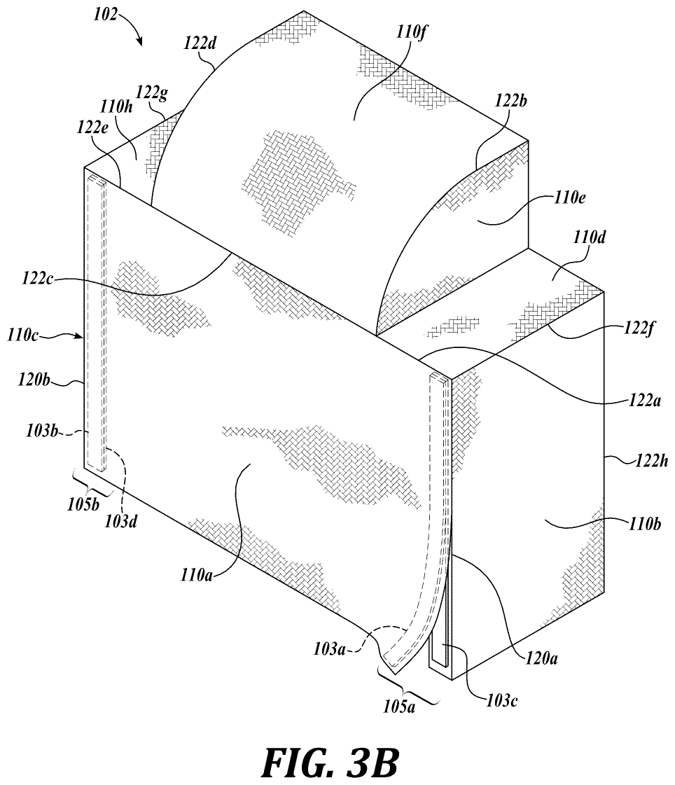

In this regard, FIG. 2A is an isometric view of a protective covering 2 configured to conform to a shape of the outdoor cooking appliance 1. In the illustrated embodiment, protective covering 2 is transparent to highlight the conformation to a shape of the outdoor cooking appliance 1. Protective covering 2 is depicted in an open configuration, as is described further herein with respect to FIGS. 3A-3B. Similarly, FIG. 2B is an isometric view of the protective covering 2 of FIG. 2A, where the protective covering 2 is depicted in a closed configuration, as is described further herein with respect to FIGS. 3A-3B. A detachable closure is formed along a portion of the protective covering 2 and is shown to include strip magnets 3a, 3b, 3c, and 3d.

While any form factor for a protective covering may be used, in some embodiments, the protective covering 2 includes a shell shape that is configured to substantively conform to a shape of the outdoor cooking appliance 1. Such a conformed shape provides numerous advantages. For example, when protective covering 2 conforms to the shape of the outdoor cooking appliance 1, the protective covering 2 may be retained on the outdoor cooking appliance during inclement weather conditions, such as heavy winds, and thus remains snuggly fit to the outdoor cooking appliance. Moreover, when protective covering 2 conforms to the shape of outdoor cooking appliance 1, the protective covering 2 does not include sections of material that hang loosely or become bunched, resulting in a trim and aesthetically appealing form factor. As a further example, when protective covering 2 conforms to the shape of the outdoor cooking appliance 1, the temperature resistant material is efficiently allocated for covering the outdoor cooking appliance, such that production cost savings can be achieved. As another example, the above form fitting structure for protective covering 2 may prevent local pooling of water following precipitation events, thus further improving the longevity of the protective covering 2 with respect to water damage.

FIG. 3A depicts a front view of a protective covering 102. In some embodiments, protective covering 102 is an example of protective covering 2. In this regard, for clarity, analogous parts are given like numbering, but in the ‘100 series. FIG. 3B depicts an isometric view of the protective covering 1022 of FIG. 3A.

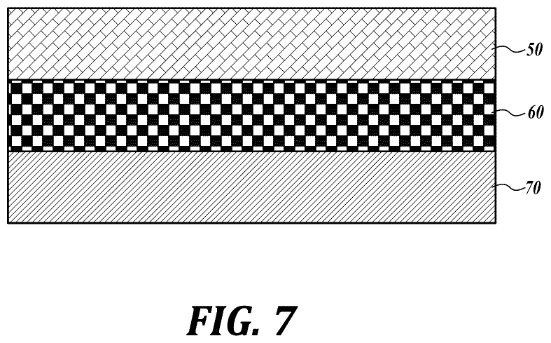

Protective covering 102 is formed from a temperature-resistant material, which will be described further herein with respect to FIG. 7. Protective covering 102 includes a plurality of panels formed from the temperature-resistant material, the plurality of panels, such as panels 110a, 110b, 110c, 110d, 110e, 110f, 110g, and 110h. While this number of panels is illustrated for clarity purposes, it should be understood that any number of panels may be used to design a shape-conforming protective cover 102, and thus more or fewer panels may be used to fabricate protective coverings within the scope of the present disclosure.

The plurality of panels are configured to be coupled together at a plurality of seams, such as seams 120a, 120b, 122a, 122b, 122c, 122d, 122e, 122f, 122g, and 122h, to define a shell shape. For instance, seam 122c is formed between panels 110a and 110f and is configured to produce a sloped curve to conform to a lid of the outdoor cooking appliance underneath, whereas seam 122a is formed between panels 110a and 110d and is configured to form a substantively right angle to conform to the flat table surface along a side of the outdoor cooking appliance. In this regard, while this number and combination of seams is illustrated for clarity purposes, it should be understood that any number of panels may be used to design a shape-conforming protective cover 102, and thus more or fewer panels may be used to fabricate protective coverings within the scope of the present disclosure.

Protective covering 102 further includes one or more detachable closures, such as detachable closures 105a and 105b, where each of the detachable closures is defined along a portion of a first seam of the plurality of seams.

In the illustrated embodiment, panels 110a, 110b, 110c, 110d, 110e, 110f, 110g, and 110h are depicted to be configured to conform to a shape of the outdoor cooking appliance the protective covering 102 is designed to protect. In this regard, panels 110a, 110b, 110c, 110d, 110e, 110f, 110g, and 110h may have similar shapes to one another, or may have distinct shapes. For instance, panel 110b and panel 110c may be substantially mirror-image identical copies of one another. Similarly, panels 110d and 110h, and panels 110e and 110g, may be substantially mirror-image identical copies of one another. Panels 110a and 110f, on the other hand, may include both a different size and shape to better conform to the respective sections of the outdoor cooking appliance. In this regard, it should be understood that, while a particular set of shapes for panels 110a, 110b, 110c, 110d, 110e, 110f, 110g, and 110h is depicted in FIGS. 3A and 3B, any combination of shapes may be used to create a shell shape that conforms to an outdoor cooking appliance, and that such variations are within the scope of the present disclosure.

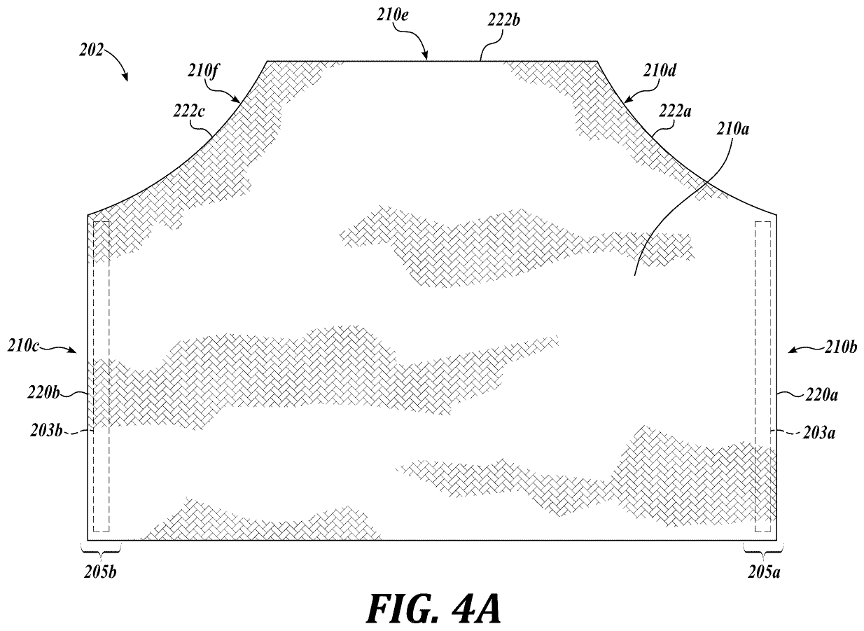

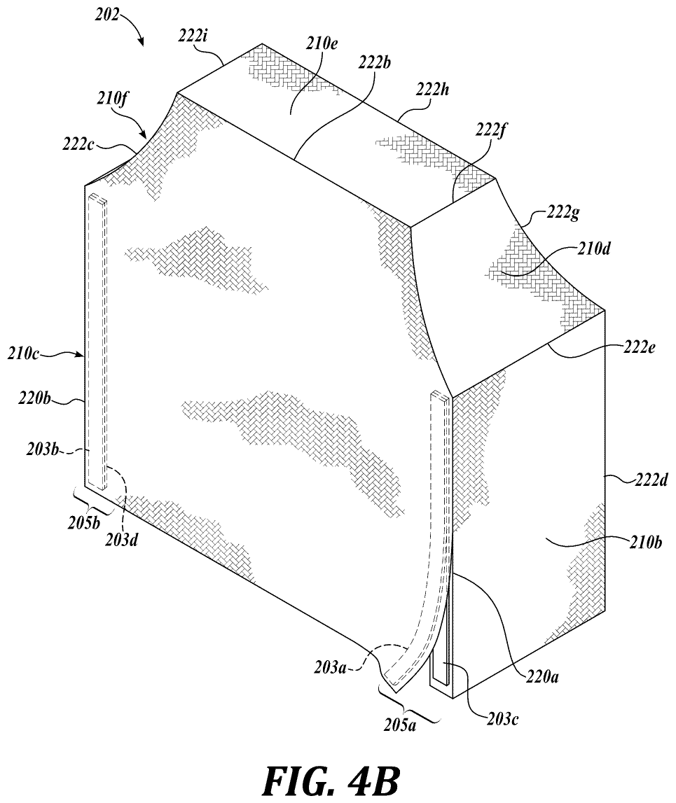

To better illustrate this variation, an example of a second shell shape for a protective covering is depicted in FIGS. 4A and 4B. FIG. 4A illustrates a front view of a protective covering 202 for an outdoor cooking appliance with a different shell shape from protective covering 102. FIG. 4B illustrates an isometric view of protective covering 202. Protective covering 202 includes a plurality of panels 210a, 210b, 210c, 210d, 210e, and 210f. The plurality of panels are configured to be coupled to one another at plurality of seams 220a, 220b, 222a, 222b, 222c, 222d, 222e, 222f, 222g, 222h, and 222i. Protective covering 202 further includes detachable closures 205a and 205b, and is depicted to include magnets 203a, 203b, and 203c. Thus, in some embodiments, protective covering 202 is an example of protective covering 102, where the shape and size of the panels of the plurality of panels, and the location of the seams of the plurality of seams, is altered so that protective covering 202 may form a shell shape that conforms to an alternate shape of an outdoor cooking appliance.

Turning back to FIGS. 3A and 3B, the plurality of seams, such as seams 120a, 120b, 122a, 122b, 122c, 122d, 122e, 122f, 122g, and 122h, couple the plurality of panels together, thereby forming the shell shape of the protective covering 102.

In the illustrated embodiment, seams 120a and 120b form part of detachable closures 105a and 105b, respectively. In this regard, seams 120a and 120b can convert between an open and closed configuration. Conversely, seams 122a, 122b, 122c, 122d, 122e, 122f, 122g, and 122h for a fixedly coupled connection between adjacent panels of the plurality of panels. Seams 122a, 122b, 122c, 122d, 122e, 122f, 122g, and 122h may be formed in a manner understood by one of ordinary skill in the art, such as a sewn connection between adjacent panels. In some embodiments, a thread used to form any of seams 122a, 122b, 122c, 122d, 122e, 122f, 122g, and 122h is a temperature-resistant thread. While 122a, 122b, 122c, 122d, 122e, 122f, 122g, and 122h are described herein as providing a fixedly coupled connection, it should be understood that any of seams 122a, 122b, 122c, 122d, 122e, 122f, 122g, and 122h may similarly be configured to form a detachable closure, and that such additional configurations are within the scope of the present disclosure.

In some embodiments, the protective covering 102 further includes one or more detachable closures, such as detachable closures 105a and 105b. In this regard, protective covering 102 may include a first detachable closure, such as detachable closure 105a, and a second detachable closure, such as detachable closure 105b. In some embodiments, detachable closures 105a and 105b are mirror image identical. Accordingly, for clarity, only detachable closure 105a shall be described.

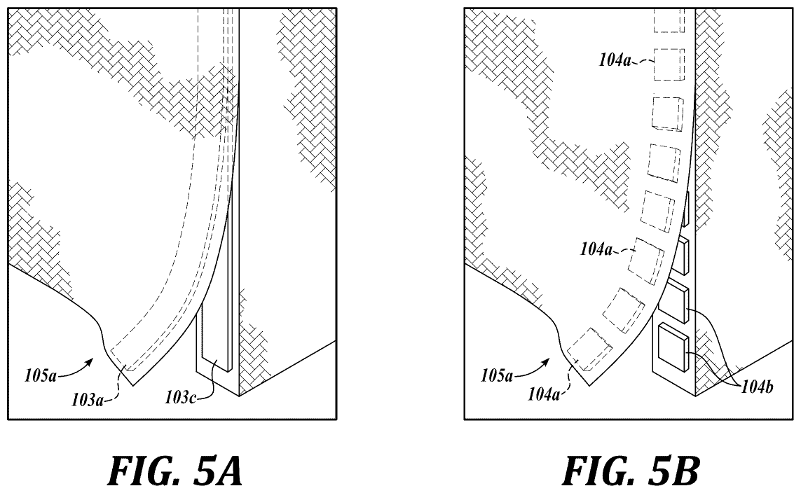

In the illustrated embodiment, detachable closure 105a is formed at seam 120a. In this regard, detachable closure 105a includes a portion of panel 110a and a portion of panel 110b, wherein the portion of panel 110a is configured to at least partially overlap the portion of panel 110b. The portion of panel 110a includes magnet 103a. The portion of panel 110b includes magnet 103c. In some embodiments, magnet 103a and magnet 103c may have a shape, wherein the shape may be a strip, a disc, a rod, a square, a rectangle, a triangle, or combinations thereof, as is discussed further herein with respect to FIGS. 5A and 5B.

FIG. 5A illustrates detachable closure 105a of the protective covering 102. FIG. 5B illustrates detachable closure 106a for the protective covering 102. Detachable closure 105a is depicted to include strip magnets 103a and 103c, as is described further herein above. An advantage of a protective covering with strip magnets, such as strip magnets 103a and 103c, is that magnets have a positive side and a negative side such that two opposing strips are magnetically attracted to one another. By including the magnets in a strip form which extends along the length of a detachable closure, such as detachable closure 105a, each of a pair of strip magnets may more readily be held in position for the opposing strips to magnetically couple to one another. Such a configuration therefore advantageously prevents one side of a detachable closure from coupling to itself. This results in a self-closing design where a user has to merely drop the protective covering over the outdoor cooking appliance, while the magnets self-assemble to form the shell shape of the protective covering, thereby protecting the outdoor cooking appliance.

In some embodiments, though, different magnet shapes may be used. For instance, detachable closure 106a includes a plurality of magnets 104a and a plurality of magnets 104b, where each magnet of the plurality of magnets 104a and 104b comprise a rectangular or square shape. In this regard, detachable closure 106a is an example of detachable closure 105a, but with different shapes to the embedded magnets. In some embodiments, such a configuration may be advantageous for improving the flexibility of panels 110a and 110b at the location of seam 120a. For instance, the plurality of magnets 104a and 104b may be thicker than magnets 103a and 103c, thus enabling an increased magnetic force holding the protective covering 102 in the closed configuration.

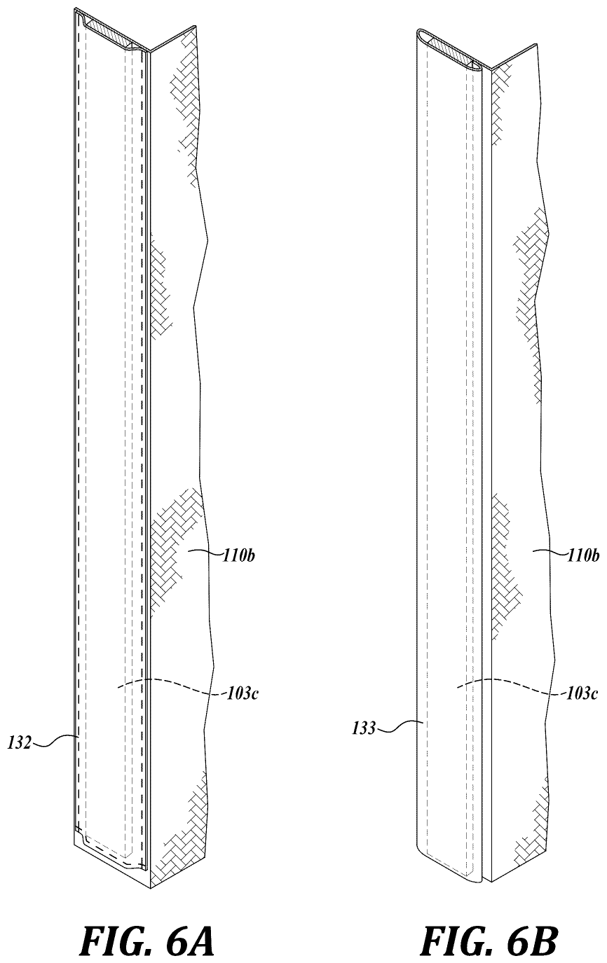

In some embodiments, magnets 103a and 103c may be embedded in the temperature resistant material in any suitable manner, such as by insertion into pockets, by sewing the magnets into panels, by the use of adhesive formulations, or by combinations thereof. In this regard, FIG. 6A illustrates a portion of panel 110b of protective covering 102, highlighting the embedding of magnet 103c in pocket 132. While pocket 132 is depicted only with respect to the portion of panel 110b for clarity, it should be understood that a similar embedding approach may be used for any of the magnets embedded in protective covering 102. An advantage of embedding magnets in pocket 132 includes the ability to remove and replace magnet 103c.

In some embodiments, such as in the embodiment depicted in FIG. 6B, the embedding of magnet 103c may be in a sleeve 133. Sleeve 133 may be formed by folding a portion of the temperature-resistant material to substantially surround magnet 103c, which can then be sewn into place. While sleeve 133 is depicted only with respect to the portion of panel 110b for clarity, it should be understood that a similar embedding approach may be used for any of the magnets embedded in protective covering 102. An advantage of embedding magnets in sleeve 133 includes a highly secured coupling of magnet 103c to panel 110b, thus improving the durability of protective covering 102.

It should be noted that other methods for coupling magnet 103c to panel 110b besides pocket 132 and sleeve 133 are within the grasp of one of ordinary skill in the art, and as such these alternative attachment methods are within the scope of the present disclosure.

Turning back to FIGS. 3A and 3B, magnet 103a and magnet 103c are in the form of paired strip magnets, where the polarity of magnet 103a and the polarity of magnet 103c is configured such that the portion of panel 110a may be detachable coupled to the portion of panel 110b. In this regard, when magnet 103a comes into proximity with magnet 103c, magnet 103a is attracted to magnet 103c, and magnet 103c is attracted to magnet 103a. As a result of the magnetic attraction, the portion of panel 110a is held in contact with the portion of panel 110b, thereby closing the protective covering 2 along the seam 120a and producing a closed configuration of the protective covering 102.

Conversely, when a force is applied to separate the portion of panel 110a from the portion of panel 110b, the magnetic force between magnets 103a and 103c that was holding together the portions of panels 110a and 110b may be overcome. When that force is overcome, the panels 110a and 110b may be separated, thereby placing the protective covering 102 into an open configuration.

In this regard, the protective covering 102 may be converted from the open configuration to the closed configuration, or from the closed configuration to the open configuration, by reversible opening or closing the protective covering 102 at the first detachable closure 105a. Similarly, the protective covering 102 may be converted from the open configuration to the closed configuration, or from the closed configuration to the open configuration, by reversible opening or closing the protective covering 102 at the second detachable closure 105b.

While two detachable closures have been described, it should be understood that additional numbers of detachable closures are possible and thus fall within the scope of the present disclosure, including the presence of three detachable closures and four detachable closures. In some embodiments, the presence of four detachable closures advantageously results in a protective covering with four flaps that can be independently opened during a covering/uncovering process. Such a configuration may further accelerate the speed at which the cover can be installed and removed. Accordingly, in some embodiments, the protective covering has four detachable closures-—each detachable closure comprising a pair of magnetic strips configured to hold the detachable closures closed—and four articulable flaps—each flap formed between two detachable closures, and the four flaps together configured to form the shell shape when the protective cover is placed onto a top of the outdoor cooking appliance—wherein the magnetic strips of the detachable closures draw the four articulable flaps into the shell shape provide a tight coupling force to hold the protective covering onto the outdoor cooking appliance.

In some embodiments, the open configuration of protective covering 102 advantageously allows for quick removal of the protective cover from the outdoor cooking appliance, such as outdoor cooking appliance 1. In some embodiments, the open configuration of protective covering 102 advantageously allows for quick covering of the outdoor cooking appliance.

One advantage of the protective cover of the present disclosure is improved ease of covering an outdoor cooking appliance and a corresponding improved ease of removal of the protective covering. For instance, with respect to removal of the protective covering, in a traditional protective covering that conforms to the outdoor cooking appliance it is designed to protect, removal of the protective covering may be slow and require care. Many outdoor cooking appliances have sharp edges that can tear at the protective covering if the user does not exercise care. To address this, many traditional protective coverings include paired hook and loop fasteners to tighten the protective cover once it is installed, such as by a cinching mechanism. While releasing these hook and loop fasteners can improve the ease of removal of a protective covering, these too must have care taken to avoid tearing, and such hook and loop fasteners may themselves get caught on other surfaces, leading to damage to the protective covering. Moreover, vinyl-coated fabrics tend to shrink over time with UV exposure, thus exacerbating these problems. The protective covering described in this disclosure, on the other hand, allows a user to quickly open a panel to rapidly remove the protective covering, without including additional external features which can catch and tear the protective covering when it is being removed. In some embodiments, the protective covering is accordingly flexible, abrasion-resistant, chemical- and cleaner-resistant, tear-resistant, puncture resistant, does not peel, does not shrink, and is colorfast and non-fading.

With respect to an improved ease of covering of the outdoor cooking appliance by the protective covering, particularly when the outdoor cooking appliance is still hot, a traditional protective covering design must be carefully manipulated to cover the outdoor cooking appliance to avoid the risk of tearing noted above. Even with the presence of paired hook and loop fasteners to tighten the protective covering, which allow for a looser initial fit for the protective covering, the protective covering must still be manipulated to position the protective covering over the outdoor cooking appliance. Particularly when the outdoor cooking appliance is still hot, this may expose the user to a risk of burns or other injuries. The protective covering described in this disclosure, on the other hand, allows a user to quickly set the protective covering over the top of the outdoor cooking appliance in the open configuration without having to manipulate or carefully position the protective covering. A tight fit can then be subsequently achieved by dropping the first panel into place, thereby bringing the detachable closures into contact—automatically, and without human intervention—thus forming a tight conforming fit to the outdoor cooking appliance. In this manner, rather than waiting two to four hours for the outdoor cooking appliance to cool down—and thus providing an ongoing safety risk to children and others who may place hands on the outdoor cooking appliance while it cools down—the protective covers of the present disclosure may be dropped into place to cover the outdoor cooking appliance immediately, such as in between 10 and 15 seconds, and with little effort by the user.

Along similar lines, the protective covers of the present disclosure allow a user to cover an outdoor cooking appliance quickly when there is a sudden need to cease use of the outdoor cooking appliance. For instance, when the outdoor cooking appliance is a portable fire pit, a user may wish to enjoy the portable fire pit on a cooler day or when there is substantial cloud cover. However, this can result in a substantial risk to the portable fire pit if the weather worsens and rain begins to fall. Under such conditions, the rainfall may be capable of damaging the portable fire pit, and thus the user is unlikely to risk using the portable fire pit when there is a risk of rain. Using a protective covering of the present disclosure, however, a user may use the portable fire pit up to the beginning of rainfall, and then may promptly cover the portable fire pit, thus extending the useful enjoyment of the portable fire pit while still providing adequate protection to the equipment.

Another advantage of the protective covering of the present disclosure is its use to improve insulation for a cooking surface. Temperature control during cooking may provide significant advantages to consistent cooking of a food product. However, ambient temperature conditions, such as cold air and wind, can result in differential cooking temperatures for an outdoor cooking appliance. The temperature-resistant material of the protective cover described herein, however, is resistant to heat generated by an outdoor cooking appliance, such as a grill or a smoker. Thus, the protective covering may be placed over the outdoor cooking appliance during operation, thereby providing insulation and improved consistency for cooking conditions. Moreover, unliked traditional cover designs, the detachable closures for the protective covering of the present disclosure allow a user to remove and reinstall the protective covering quickly and without difficulty, thus allowing a user to access the cooking surface when needed, and to subsequently re-cover the cooking surface for continued insulation and temperature control.

A further advantage of the protective cover of the present disclosure is improved temperature resilience. Other methods of quick fastening—including hook and loop fasteners and zippers—typically include materials that may be damaged when exposed to high temperatures, or that can otherwise become damaged and non-functional. Magnets, such as ceramic magnets, embedded within the temperature-resistant material, on the other hand, may be resistant to high temperatures and thus improve the durability of protective coverings of the present disclosure.

Another advantage of the protective cover of the present disclosure is an ability to use the protective cover as an additional safety feature in the case of grease fires. All existing covers, including the few available high-temperature covers, are unable to be used in a grease-fire situation to quickly and easily cover the hot units to smother and extinguish the fire in seconds. Being able to quickly cover and extinguish a fire without exposing oneself to a harmful and permanent burn and bodily injuries can make the difference in saving a home, building, or hotel from burning down, potentially saving numerous lives and valuable real estate.

FIG. 7 illustrates an order of the layering of materials in the temperature-resistant material of the protective covering 102. In this regard, protective covering 102 includes a topcoat resin 50, a fabric layer 60, and a bottom coat resin 70. In some embodiments, the resin used in the topcoat 50, fabric layer 60, and bottom coat 70 may be the same resin. In some embodiments, the resin used in the topcoat 50, and bottom coat 70 may each be different.

The topcoat 50 provides for weather resistance, and as such the topcoat being the exterior is coated more heavily resulting in a solid coating that is low in surface energy for water/weather proofing. Accordingly, in some embodiments, topcoat 50 is thicker than bottom coat 70, thus improving the protective qualities of topcoat 50. The fabric layer 60 provide for structural integrity and flexibility as well as providing a compatible surface for the top and bottom coats. The bottom coat 70 provides for thermal resistance and for a slick surface. Accordingly, in some embodiments, bottom coat 70 is thinner than topcoat 50.

While FIG. 7 depicts a layering between layers 50, 60, and 70, in some embodiments, both sides of the fabric layer 60 can be impregnated with topcoat resin 50 and bottom coat 70. In some embodiments, both sides of the fabric layer 60 may be fully coated with topcoat resin 50 and bottom coat 70. In some embodiments, the resin of bottom coat 70 is more impregnated into fabric fibers of fabric layer 60 than the resin of topcoat 50 is impregnated into fabric fibers of fabric layer 60. In some embodiments, impregnating the interior of fabric layer 60 may advantageously lower the coefficient of friction of an interior surface of the protective coating such that a coefficient of friction of bottom coat 70 is lower than a coefficient of friction of topcoat 50, which results in the cover the ability to slide onto an outdoor cooking appliance and/or storage shelf.

In some embodiments, fabric layer 60 may be a woven or non-woven fabric where the fibers of the fabric are not coated with a resin. In this regard, in some embodiments, fabric layer 60 may be coated with only topcoat 50, only bottom coat 70, or with both topcoat 50 and bottom coat 70.

In some embodiments, fabric layer 60 may be a woven fabric, a non-woven fabric, or a combination thereof. In some embodiments, an exterior surface of the fabric is impregnated and coated with topcoat 50, the interior of the surface of the fabric is impregnated and coated with bottom coat 70, or both the exterior and interior surfaces are impregnated and coated with topcoat 50 and bottom coat 70.

In some embodiments, the temperature-resistant material comprises a waterjet entangled fibers fabric layer coated with a silicone coating. In some embodiments, the temperature-resistant material comprises a silicone-coated fiberglass.

In some embodiments fibers of the fabric layer comprise short fibers selected from chopped fibers, staple fibers, or a combination thereof. In some embodiments, the fibers are aramid fibers. In some embodiments, the fibers have an average filament diameter in a range of between about 4 μm and about 600 μm, about 4 μm and about 300 μm, about 4 μm and about 100 μm, about 4 μm and about 50 μm, about 4 μm and about 15 μm, about 5 μm and about 600 μm, about 5 μm and about 300 μm, about 5 μm and about 100 μm, about 5 μm and about 50 μm, and about 5 μm and about 15 μm. In some embodiments, the fabric layer is made in a specialized water jet process, rather than needle-punched, needled, spunbond, or carded process. In some embodiments, smaller-diameter fibers, such as those in the recited ranges, create a more uniform, better-insulating substrate. In some embodiments, fibers larger than the recited ranges are lower the cost than smaller-diameter fibers, but such large fibers have lower insulating properties.

In some embodiments, the resin used in topcoat 50 and/or bottom coat 70 is inherently UV resistant. In some embodiments, white fillers are embedded in the resin used in topcoat 50 and/or bottom coat 70, resulting in a coating opaque to block UV penetration to the fabric layer 60. In some embodiments, the addition of black pigment further improves UV blocking to protect fibers of the fabric layer 60.

In some embodiments, topcoat 50 and bottom coat 70 are configured to be abrasion resistant, heat resistant, UV resistant, and chemical cleaner resistant. In some embodiments, topcoat 60 and bottom coat 70 are anti-microbial. In some embodiments, topcoat 50 and bottom coat 70 are sea salt spray resistant, hydrolysis resistant, low temperature flex resistant, colorfast, non-staining, or combinations thereof. In some embodiments, topcoat 50 and bottom coat 70 comply with Restriction of Hazardous Substances (RoHS) 2.0, Registration, Evaluation, Authorisation and Restriction of Chemicals (REACH) Substances of Very High Concern (SVHC) 181, and California Prop. 65. In some embodiments, topcoat 50 and bottom coat 70 generate no VOC's, are odoroless, result in zero leaching of pollutants to air and water, are free of toxic heavy metal elements such as chromium, cadmium, antimony, arsenic, mercury, and lead. In some embodiments, topcoat 50 and bottom coat 70 are free of formaldehyde, phtahlates, bisphenol A (BPA), per- and poly-fluoro alkyl substances (PFAS), alkylphenol ethoxylates (APEO), nonylphenol ethoxylates (NPEO), octylphenol ethoxylates (OPEO), and pentachlorophenol.

In some embodiments, the temperature-resistant material has a thickness of between about 0.30 mm and about 6.0 mm, about 0.30 mm to about 5.0 mm, about 0.30 mm to about 4.0 mm, about 0.30 mm to about 3.0 mm, about 0.30 mm to about 2.0 mm, about 0.50 mm to about 6.0 mm, about 0.50 mm to about 5.0 mm, about 0.50 mm to about 4.0 mm, about 0.50 mm to about 3.0 mm, and about 0.50 mm to about 2.0 mm. An advantage of a thickness of 0.30 mm or greater is an improved durability, an improved insulating property, or combinations thereof. An advantage of a temperature resistant material with a thickness of less than 6.0 mm is a lighter more manipulable protective covering, and/or one with a lower production cost.

### EXAMPLES

### Example 1

Advantages of the temperature-resistant materials described herein include the level of fire resistance and weather protection offered by the protective coverings of the present disclosure. For instance, the temperature-resistant material provides UV resistance for 20 years. The temperature-resistant material does not get stiff, crack, flake, rip, tear, get holes, or shrink from normal usage as a protective covering, thus improving the longevity of the protective coverings. In this regard, while traditional protective coverings may need to be replaced every 2-5 years to continue providing adequate protection, the lifetime of the protective coverings described herein may be between 15 and 20 years, or longer.

The presented materials that comprise the coverings or mats are resistant to High Temperatures. The Base Fabrics that comprise the coverings or mats are resistant 500-degrees F. to 2000-degrees F. Silicone Rubber coating for woven or non-woven fabrics are resistant to temperatures of 500-degree F. continuous temperature with excursions to 1200-degrees F. for short periods. The thermal conductive properties of the covers and mats render the covers and mats poor conductors of heat. The insulating properties of the disclosed protective coverings prevents burns if accidentally touched by children, pets, or adults.

The special silicone rubber used in the protective coverings described herein covers have low surface energy properties, The low surface energy of the silicone resin renders the protective coverings disclosed herein dirt and ash resistant. The protective coverings disclosed herein are easy to clean and are even self-cleaning in rain. The temperature-resistant properties of protective coverings disclosed herein can be put on the Grill, Smoker, or Firepit/Portable Campfire immediately after cooking. There is not any time required to allow for a cool down for the protective coverings disclosed herein, as such, there is not any need to wait for units to reach ambient temperatures before covering the units. Covering a hot unit with a protective coverings disclosed herein takes less than 10 seconds without danger of burns and bodily injury.

The protective coverings disclosed herein are equipped with magnets. The magnets render the covers self-closing with the polarized flexible magnet strips in flanges on side edge seams. If the grill or smoker has a grease fire, a user may simply place or throw the protective coverings disclosed herein over the grill or smoker, and the self-closing covers with magnetic closing strips will smother and extinguish the fire in seconds, saving real estate and countless lives.

In cold weather and windy conditions, the protective coverings disclosed herein may be left on grill hoods with the sides folded on top of the hood to provide insulation for the cooking units which saves energy/fuel and provides for even heating and dependable cooking times. The protective coverings disclosed herein covers provide ease, convenience, and safety, and save precious time.

### Example 2: Temperature-Resistant Fabric Materials

A component of the protective coverings disclosed herein is the woven or non-woven fabric consisting of a substrate of fibers. The Base Fabric Fibers include NOMEX®, KEVLAR®, and fiberglass (E-Glass) which are the currently preferred fibers for performance and price. NOMEX® and KEVLAR® are both inherently flame-resistant, high-temperature resistant fibers that will not melt, drip, or support combustion in air. They are offered in paper, felt, fabric, and fiber forms, either of one fiber or in blends of both fiber types. They do not absorb water. Spunlaced fabrics which are a type of non-woven fibers are suitable for the protective coverings disclosed herein. Single layer, multi-layered or quilted Spunlaced fibers can all be used as cost is a factor.

The lowest cost base fabric are typically forms of non-wovens produced with short fibers. Spunlaced fabrics are low density, formidable strength, and low cost. KEVLAR®, Basalt, S-Glass Fiberglass, Ceramic Fibers, carbon fibers, carbon polyacrylonitrile (PAN) based fibers, and high silica fabrics offer unique qualities to the protective coverings disclosed herein to their specific physical characteristics and properties and can fit in the price range the market will accept. Polybenzimidazole (PBI), polybenzoxazole (PBO), Silica/Alumina blends, Quartz, and specialty ceramic fibers will work to the level of their physical properties and offer unique characteristics yet are not priced for market acceptance. The primary composition of fibers for the woven or non-woven fabric may be selected from the group consisting of: NOMEX®, KEVLAR®, PBI, PBO, Fiberglass, E-Glass, S-Glass, Basalt, Silica, PAN pre-oxidized carbon fibers, and combinations thereof. Alternative fibers for the composition of fibers for the woven or non-woven fabric include Leached Silica, known as high silica, above 65% SiO2 up to 98% SiO2 with others may be selected from the group consisting of Silica/Alumina blends, Quartz, Ceramic Fibers, Alumina-Silica, Alumina, and combinations thereof.

The non-woven fabric fiber component of the protective coverings described herein is a chopped or staple fiber that has been “opened” or “carded”. It is them formed into a non-woven fabric by one of many methods, including “spunlaced”. The woven fabric fiber component of the protective coverings described herein is constructed into a yarn. Yarn constructions suitable for the protective coverings described herein include Spun, Craq-Spun, and Core-Spun yarns have been shown to work well. However, when coated these yarn types do not provide for a smooth finish and the coating is more likely to trap dirt. Silk screening of brand names is also less effective with a coated fabric surface that is not smooth. Texturized yarns also are not as favorable for similar reasons. Filament yarns are the yarns of choice for protective coverings described herein due to the smooth finished fabric structure provided by the smooth yarns but can be cost prohibitive depending on the fiber chosen and yarn denier.

The twisted and plied yarns which used for protective coverings described herein add relief and texture as well as strength; however, there are added costs of twisting and plying yarns. “Singles” yarns with a very low twist in the “Z” counterclockwise direction or no twist such as “roving's” function well for the protective coverings described herein. The various yarn constructions suitable for the protective coverings described herein are selected from the group consisting of filament, roving spun all types, Texturized, twisted, plied, and combinations thereof.

The fabric fiber component of the protective coverings described herein can be made of various fabric forms. Woven fibers for protective coverings described herein is preferred; however, non-woven will also work for protective coverings described herein and is less expensive. Non-wovens can be stiffer after coating. Non-woven fabrics such as needled felt, paper, veil, wet-laid, hot-melt, and stitch-bonded may be more prone to catching and tearing. Furthermore, the aforementioned non-wovens being less drape-able will not be as easy to have the cover almost “self-install” and seal itself on the edges with magnetic strips. Spunlaced non-wovens are the preferred non-woven as they have suitable drapability and flexibility plus superb strength over other non-woven fabrics.

Non-woven materials are currently more cost effective than woven materials. Knitted structures also function well for the protective coverings described herein; however, many knitted fabrics accept higher coating weights adding expense, thickness, and weight so knitted fabrics are not preferred. Knitted fabrics of very fine gauge between 8 and 40 gauge are thinner and can be knitted more densely to reduce coating weight additions and lower cost, yet the trade-off for fine denier yarns (20 Denier to 120 Denier in one embodiment, 20 to 1000 Denier in another embodiment, 20 to 1500 Denier in another embodiment, 20 to 2000 Denier in another embodiment) and slow knitting production times add cost to make the products currently undesirable from a cost standpoint. Braided fabrics also function well for the protective coverings described herein, but braided fabrics are also not cost effective.

The coating component of the protective coverings described herein may be made of various materials. The coating generally comprises a polymer. The polymer can be linear, branched or crosslinked. Silicone Rubber is the preferred coating material for the protective coverings described herein, especially silicones with low-surface energy that are typically used in architectural coated fabrics due to their ability to prevent dirt from sticking and staying clean. Standard silicone rubber works well too for the protective coverings described herein, but that type of silicone has a higher surface energy which attracts dirt that is harder to remove and clean to its original condition.

It is still easier to clean than the current vinyl coated fabrics used today which are higher surface energy than Silicone rubber. PTFE functions well for the protective coverings described herein and is a polymer of choice due to its temperature range and low surface energy. PTFE is available in various forms ranging from crystalline to rubber. Some forms of PTFE may contain PFAS chemicals that are hazardous; and, while functional for the protective coverings described herein are less desirable for hazard reasons. The various coating polymers suitable for the fibers used for the protective coverings described herein are selected from the group consisting of Silicone Rubber, Low Surface Energy Dirt-repelling Silicone Rubber, PTFE (All Teflon Family of products, TFE, FEP, etc.), and combinations thereof.

### Example 3: Magnet Materials

Magnets allow for the protective coverings described herein to self-seal on the Grill, Smoker, or Firepit/Portable Campfire. A type of magnet suitable for the protective coverings described herein is the Flexible Magnetic Strip, Non-Adhesive, High Energy type magnets, such as magnet 103a depicted in FIGS. 3A and 3B. These non-adhesive flexible magnets (Type N) have maximum holding power on one side. The magnetic strips consist of ferrite in a dark brown thermoplastic binder. These strips feature multi-pole magnetization for maximum magnetic strength.

### Example 4: Fabrication and Product Variations

The covers are produced by cutting the coated fabric into panels and then sewn with high temperature sewing thread. KEVLAR®, NOMEX®, or fiberglass threads. The magnets are sewn into pockets along the edges of the front, sides, and back panels from the side tables down to the ground. SS Snaps are placed at the corners of the panels at the bottom so they can be snapped together during windstorms to prevent the cover from blowing off. Branding logos may be silkscreened onto the front top panel to help identify the front of the cover. Firepit/campfire covers will have a round or rectangular shape and still have magnet strips for automatic closing when the cover is dropped on top of the unit.

The covers may be one layer thick or insulated and quilted depending on if it is a storage cover or a cooking cover to save fuel and control even temperatures. Some of the various applications of the protective coverings described herein include BBQ/Grill Protective Storage Covers, BBQ/Grill Insulating Cooking Covers, Firepit/Campfire Protective Storage Covers, and Grill and Firepit/Campfire Protective Mats.

The detailed description set forth above in connection with the appended drawings, where like numerals reference like elements, are intended as a description of various embodiments of the present disclosure and are not intended to represent the only embodiments. Each embodiment described in this disclosure is provided as a representative example or illustration and should not be construed as preferred or advantageous over other embodiments. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification. That is, the present disclosure includes embodiments that combine features from different embodiments.

In the above description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

In the detailed description herein, references to “one embodiment”, “some embodiments”, “an embodiment”, “an example embodiment”, “one or more embodiments, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

In the claims and for purposes of the present disclosure, the terms “a”, “an”, “the”, and the like, refer to the singular and the plural forms of the object or element referenced.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Such computers, controllers and data processors may include a non-transitory computer-readable medium with executable instructions. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

1. A protective covering comprising:
a temperature-resistant material comprising:
a fabric layer,
a resin topcoat coating a first side of the fabric layer, and
a resin bottom coat coating a second side of the fabric layer;
a plurality of panels formed from the temperature-resistant material, the plurality of panels being coupled at a plurality of seams to define a shell shape; and
a first detachable closure defined along a portion of a first seam of the plurality of seams.

2. The protective covering of claim 1, wherein the temperature-resistant material has a thickness of between about 0.30 mm and about 6.0 mm.

3. The protective covering of claim 1, wherein the temperature-resistant material comprises short fibers selected from chopped fibers, staple fibers, or a combination thereof.

4. The protective covering of claim 1, wherein the temperature-resistant material comprises a non-woven fabric, a woven fabric, or a combination thereof.

5. The protective covering of claim 3, wherein the short fibers are waterjet entangled without the use of additional binders.

6. The protective covering of claim 3, wherein the short fibers have an average filament diameter of between about 4 μm and about 600 μm.

7. The protective covering of claim 1, wherein the fabric layer is selected from the group consisting of NOMEX®, fiberglass, E-Glass KEVLAR®, Basalt, S-Glass fiberglass, Ceramic Fibers, high silica, polybenzimidazole (PBI), polyphenylene benzobisoxazole (PBO), Silica/Alumina blends, Quartz, leached silica, Alumina-Silica, specialty ceramic fibers, carbon fibers, carbon polyacrylonitrile (PAN) based fibers, polyacrylonitrile carbon pre-oxidized fibers, and combinations thereof.

8. The protective covering of claim 1, wherein the resin comprises NOMEX®, KEVLAR®, or combinations thereof.

9. The protective covering of claim 1, wherein the resin is a low surface energy resin.

10. The protective covering of claim 1, wherein the resin is UV-resistant.

11. The protective covering of claim 1, wherein the resin is configured to provide a waterproof coating.

12. The protective covering of claim 1, wherein the resin is selected from the group consisting of silicone, silane, siloxane, RTV, PTFE, PTF, polyvinylidene fluoride, FEP, FKM, polyurethane, and combinations thereof.

13. The protective covering of claim 1, wherein the resin comprises silicone.

14. The protective covering of claim 1, wherein the topcoat is configured to provide a waterproof coating.

15. The protective covering of claim 1, wherein the bottom coat is configured to provide thermal resistance.

16. The protective covering of claim 1, wherein the temperature-resistant material is resistant to a temperature of about 500° F. to about 2000° F.

17. The protective covering of claim 1, wherein the first detachable closure comprises a first magnet and a second magnet in a paired configuration.

18. The protective covering of claim 1, wherein the first detachable closure is formed from a portion of a first panel of the plurality of panels and from a portion of a second panel of the plurality of panels.

19. The protective covering of claim 1, further comprising a second detachable closure defined along a portion of a second seam of the plurality of seams.

20. The protective covering of claim 19, wherein the second detachable closure is formed from a portion of the second panel of the plurality of panels and from a portion of a third panel of the plurality of panels.
